(19) United States
(12) Patent Application Publication
(10) Pub. No.: US 2020/0273054 A1
(43) Pub. Date: Aug. 27, 2020

(54) DIGITAL RECEIPTS ECONOMY

(71) Applicant: Intel Corporation, Santa Clara, CA (US)

(72) Inventors: Rita H. WOUHAYBI, Portland, OR (US); Richard T. BECKWITH, Portland, OR (US); Jose K. SIA, JR., Portland, OR (US); Timothy G. COPPERNOLL, Portland, OR (US); Sai P. BALASUNDARAM, Beaverton, OR (US); Lama NACHMAN, Santa Clara, CA (US); Ryan S. BROTMAN, Beaverton, OR (US); David I. SHAW, Portland, OR (US)

(21) Appl. No.: 16/872,276

(22) Filed: May 11, 2020

Related U.S. Application Data
(63) Continuation of application No. 14/780,531, filed on Sep. 26, 2015.
(60) Provisional application No. 61/838,340, filed on Jun. 24, 2013.

(51) Int. Cl. G06Q 30/02; G06Q 30/06; G06Q 40/00; G06Q 10/08

(52) U.S. Cl. CPC G06Q 30/0204; G06Q 30/06; G06Q 30/0207; G06Q 40/12; G06Q 10/087; G06Q 30/02

(57) ABSTRACT

Techniques to extract data from computer-readable purchase records of a user, cluster the items of interest based on descriptions of the items, and associate descriptive keywords to the clusters, where the keywords represent interests of the user. One or more processes and/or functions may be performed on extracted data, including cluster-specific processes and/or function, including user-based, user interest-based, and/or crowd-based processes and/or function, which may include shopping pattern extraction, item or types of items availability based on time, location and other contextual metric, pricing data of items and expected pricing changes over time and seasonal variations, identification of user preferences, and/or shopping recommendations.

### CROSS REFERENCE TO RELATED APPLICATIONS

The present application is a continuation application of U.S. patent application Ser. No. 14/780,531, which is a national phase entry under 35 U.S.C. § 371 of International Application No. PCT/US2014/038759, filed May 20, 2014, entitled “DIGITAL RECEIPTS ECONOMY,” which claims the benefit of U.S. Provisional Patent Application 61/838,340, filed Jun. 24, 2013, which designates the United States of America, the entire disclosures of which are hereby incorporated by reference in its entirety and for all purposes.

### TECHNICAL FIELD

Features disclosed herein generally relate to user-interest determination, shopping/purchasing pattern extraction, and user preference analysis, based on purchase history of a user and/or crowd, such as to recommend, without limitation, shopping lists and travel routes.

### BACKGROUND

Many retailers are moving to paperless or electronic receipts (E-receipts). An E-receipt may be sent to an electronic mail (e-mail) address provided by the purchaser at the point of purchase, and or an e-mail address associated with an account, such a loyalty, or rewards program or aggregated at a receipt online service. For retailers, E-receipts may reduce costs, improve reach to customers and knowledge of customer shopping patterns, which may be useful in recommending items to a customer and in profiling consumption by a customer. For consumers, E-receipts are an easy way to retain receipts and to maintain receipts in a central repository for subsequent access, such as for returns and/or exchanges or even financial management applications.

It would be helpful to a consumer to have access to current shopping data regarding items of interest (goods and/or services), such as product/service lines of various sources (e.g., store, vendor, distributor, manufacturer, and/or producer), seasonal variations in product/service lines, current inventory, costs (e.g., listed or base price, applicable coupons, discounts, and/or customer rewards), and/or store locations. It would be impractical, if not impossible, for a single consumer to gather such data with respect to multiple categories of items and multiple sources. It would be even more daunting where the consumer has an interest and/or preference with respect to specific features of an item, such as ingredients or labeling.

Some sources alert customers of promotions via electronic mail and/or text message. Sources generally do not provide inventory data to customers.

A source may permit a customer to select items through a website and add the selected items to a shopping list associated with the customer. Such shopping lists are limited to the product/service line of the source. Such shopping lists are also not portable to other sources.

### BRIEF DESCRIPTION OF THE DRAWINGS

For illustrative purposes, one or more features disclosed herein may be presented and/or described by way of example and/or with reference to one or more drawing figured listed below. Methods and systems disclosed herein are not, however, limited to such examples or illustrations.

FIG. 1 is a block diagram of a system to identify items of interest to a user based on data extracted from one or more data sources, including a source of user purchase records, and to identify areas or subjects of interest to the user based on the items of interest.

FIG. 2 is a block diagram of a data collection system to collect computer-readable data from one or more data sources that include a source of computer-readable electronic purchase records of a user, such as digital receipt provided via electronic mail.

FIG. 3 is a block diagram of a system that includes features described above with reference to FIG. 1, and further includes an analysis module to derive data from the extracted data, such as shopping patterns and/or shopping preferences.

FIG. 4 is a block diagram of a system that includes features described with reference to one or more of FIGS. 1-3, and further includes a recommendation module to provide user-specific recommendations based on the extracted data and/or the derived data.

FIG. 5 is a block diagram of a system that includes features described with respect to one or more of FIGS. 1-4, and further includes a crowd-source system, or cloud server to store and/or manage anonymized crowd-sourced data.

FIG. 6 is a block diagram of a system that includes features described with respect to one or more of FIGS. 1-5, and further includes an application module to perform one or more functions and/or provide one or more services based on the extracted data and/or derived data.

FIG. 7 is a block diagram of a system that includes features described with respect to one or more of FIGS. 1-6, and further includes a shopping application to, which may be configured to permit a user to tag items of interest, and/or provide a shopping recommendation to the user.

FIG. 8 is a block diagram of a computer system configured to extract data from purchase records of a user, learn user purchasing behavior and user interests from the extracted data, and perform a user-specific function and/or provide a user-specific service based on the purchasing behavior and user interests.

FIG. 9 is a block diagram of example storage media that may be provided with the computer system of FIG. 8.

FIG. 10 is an illustration of a user device that includes a processor and memory, a user interface, and a communication system.

FIG. 11 is a flowchart of a method of analyzing shopping history of a user.

FIG. 12 is a block diagram of a system to organize and selectively disclose crowd-sourced shopping information based on contextual relations.

In the drawings, the leftmost digit(s) of a reference number identifies the drawing in which the reference number first appears.

### DETAILED DESCRIPTION

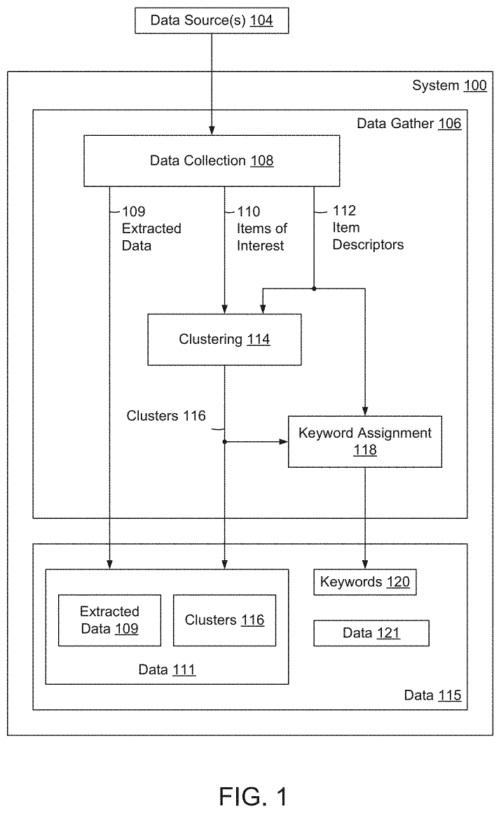

FIG. 1 is a block diagram of a system 100 to extract data to identify items of interest, and to identify areas or subjects of interest based on the items of interest. System 100 may be configured to identify the items of interest and areas or subject of interest with respect to a user and/or a crowd.

The term “user,” as used herein, may include an individual, a group or crowd of individual, and/or an entity or group of entities. For illustrative purposes, one or more examples herein may designate a user with an arbitrary name (e.g., Alice or Bob). No inferences should be drawing from such arbitrary names.

The term “item,” as used herein, may include a product or service.

The term “source,” as used herein, may include, without limitation, a vendor or store, a store location, a manufacturer, producer, distributor, and/or a service provider.

The term “communication network,” as used herein, may include, without limitation, a wired network, a wireless network, a packet-based network, a telephone network, a public network, and/or a private network.

The term “availability data,” as used herein, may include data related to inventory, source, location, and/or cost.

The term “cost,” as used herein, may include a list or base price, and/or a promotion, such as an applicable coupon, discount, credit, and or customer rewards or customer loyalty program.

In FIG. 1, system 100 includes a data gather system 106 that includes a data collection module 108 to identify items of interest (items) 110 and descriptions of items 110, illustrated here as item descriptors 112.

Data collection module 108 may be configured to represent items 110 as data objects, such as database entries, graph nodes, and/or other computer-readable representations. Data collection module 108 may be further configured to tag or append item descriptors 112 to the corresponding data objects (e.g., as metadata). Item descriptors 112 may also be referred to herein as descriptive tags, or descriptive metadata.

System 106 further includes a cluster module 114 to cluster items 110 based on corresponding item descriptors 112, and to output corresponding clustered items (clusters) 116. Cluster module 114 may be configured to cluster items 110 based on similarities and/or dissimilarities of item descriptors 112. An item 110 may be assigned to one or more clusters 116.

Cluster module 114 may be dynamically configurable (e.g., automatically and/or user-configurable), with respect to granularity, assignment criteria, and/or other factors, such as to manage or regulate the number of buckets, distinctions/distances between buckets, and or subject matter of one or more of the buckets. Cluster module 114 could map to pre-defined and negotiated clusters among users or be user-specific. Cluster module 114 may, for example, permit a user to select and/or define one or more assignment criteria of a bucket, in addition to and/or instead of item descriptors 122. Cluster module 114 may permit a user to associate an item in a cluster 116 with one or more other clusters 116, and or to move an item from one cluster 116 to another cluster 116 (i.e., override a clustering decision).

System 106 may include an automated keyword assignment module 118 to assign, associate, and/or append a set of one or more tags or keywords 120 to each cluster 116. Keywords 120 may include descriptive keywords. Keywords may be determined and/or selected for a cluster based on item descriptors 112 of the items assigned to the cluster. Alternatively, or additionally, keyword assignment module 118 may be configured to interface with public databases and/or application programming interfaces (APIs) that collect user-generated tags and/or or ontology assigned keywords.

Where items 110 represent items of interest of a user, each cluster 116 may inherently represent interest of the user. In this example, clusters 116 and corresponding descriptive keywords 120 may permit more intuitive data interaction by the user and/or with respect to the user, examples of which are provided further below.

Clusters 116 and/or associated descriptive keywords 120 may be accessible to an application, examples of which are provided further below.

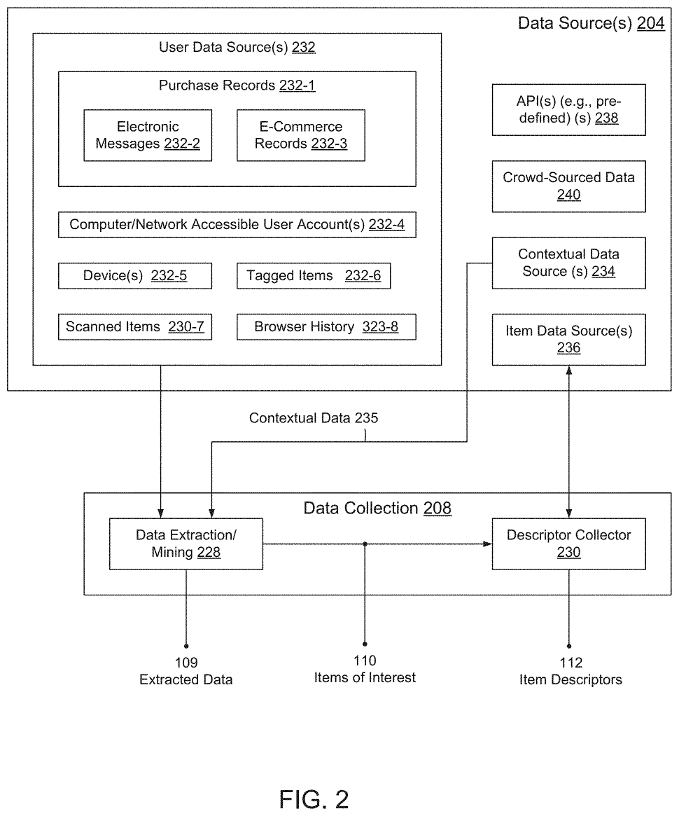

Data collection module 108 may be configured as described below with reference to FIG. 2. Data source(s) 104 may include one or more data sources described below with reference to FIG. 2. Data collection module 108 and data source(s) 104 are not, however, limited to the example of FIG. 2.

FIG. 2 is a block diagram of a data collection system 208 to collect computer-readable data from one or more data sources 204, which may accessible over one or more communication networks (e.g., through a local and/or web based application, such as a browser).

Data collection module 208 includes a data extraction/mining module 228 to identify items of interest (items) 210 from user data source(s) 232. Data extraction/mining module 228 may be further configured to collect contextual data from contextual data source(s) 236.

Data collection module 208 further includes a descriptor collector 230 to collect descriptive data for items 210 from data source(s) 236.

In FIG. 2, data source(s) 204 includes user data sources 232.

A user data source may include computer-readable purchase records 232-1, also referred to herein as digital receipts 232-1. A purchase record 232-1 may be computer-generated (e.g., at the time of purchase), and/or may be an electronically scanned image of a tangible purchase record such as a printed store receipt. Purchase records 232-1 may pertain to items of multiple interests and/or multiple sources of items.

In FIG. 2, purchase records 232-1 include electronic messages (messages) 232-2, which may include text-formatted purchase receipts sent over a communication network. A message 232-2 may include, without limitation, electronic mail (e-mail) and/or text message. A message 232-2 may be sent from a source and/or payment processor to a user account, user service, and/or user device. Messages 232-2 are not, however, limited to these examples.

Purchase records 232-1 further include E-commerce records 232-3. E-commerce records 232-3 may include itemized purchase records maintained by a vendor, payment processor, financial institution, and/or a service that catalogues electronic receipts for the user. E-commerce records 232-3 may pertain to purchases in cash/check and/or electronic funds. Electronic funds may include financial transaction card purchases (e.g., credit, debit, and/or gift cards), electronic funds transfer (e.g., bank-to-bank), and or digital currency (i.e., virtual or alternative currency used in computer-based virtual economies).

User data source(s) 232 may include a computer and/or network accessible user account 232-4 and/or include one or more user devices 232-5.

User data source(s) 232 may include a source(s) of user tagged items 232-6, such as an electronic shopping list and/or wish list, which may be stored in one or more devices and/or on a server of a vendor, which may be accessible through a computer-based interface (e.g., browser and/or web app).

User data source(s) 232 may include browser history 323-8, and may include browser history associated with items sources (e.g., on-line vendor sites), such as items viewed, tagged, and/or purchases.

User data source(s) 232 may include a source of scanned items (e.g., a barcode printed on an item and/or radio frequency identification (RFID) affixed to an item and/or in a vicinity of an item.

Data source(s) 204 may include a contextual data source(s) 234 to provide contextual data 235. Contextual data source 234 may include a user device, a sensor of a user device (e.g., location positioning sensor), and/or other sensor, and/or a network source. Contextual data 235 may have some relationship to a user, an item, an interest, and/or a shopping trip. Contextual data 235 may relate to and/or occur within a time window of an event, such as a purchase, and/or within a geographic range of the event.

Contextual data 235 may include, without limitation: location data (e.g., from a global positioning satellite (GPS) system within a user device); an entry in a user electronic calendar for an event within the time window of the purchase; an electronic shopping list of the user; weather data; a road map; traffic conditions data; a public event; a communication between the user communication device and another communication device (e.g., an e-mail or text message); and/or previous similar purchases from the user and other profiling information.

Contextual data 235 may be used to identify user-base and/or crowd-based interests and or behavioral patterns, such as described in one or more examples herein.

Data extraction/mining module 228 may be configured to identify one or more of the following features or data types from user data source(s) 232: item name/type; description of item; name of purchase source; location of purchase source; purchase date; purchase price; purchase promotion under which an item is purchased (e.g., coupon, discount, credit, and/or rewards program); form and/or source of payment funds; and/or metadata.

Data extraction/mining module 228 is not, however, limited to these examples.

Descriptor collector 230 may be configured to identify one or more other data sources 236 from which to access/retrieve descriptive data for items 210. A data source 236 may include, without limitation website of a vendor, store and/or other source, and or of public service web site.

Descriptor collector 230 and/or data extraction/mining module 228 may be configured to extract descriptive data from identified source(s) 236. Data extraction/mining module 228 may be configured to perform functions described above with respect to descriptor collector 230.

Data extraction/mining module 228 and/or descriptor collector 230 may be configured to additional data based on items 210 and/or descriptors 212, such as: item details; another source of the item; item metadata contributed by seller, manufacture, and customers; profiles of users who purchased or are likely to purchase the item; similar items (from same and/or other source); and item availability data.

Item details may include, without limitation, a manufacturer, producer, grower, and/or distributor, a registered mark, a generic name, and/or labeling data. A registered mark and/or labeling may include, without limitation, organic, certified, gluten free, sugar free, vegetarian, vegan, pareve, kosher, halal, and combinations thereof.

Data extraction/mining module 228 and/or descriptor collector 230 may be configured to extract data described above, other data and/or metadata from purchase records 232-1, other data sources described above, and/or other data sources such as, without limitation, crowd-sourced data 240 and/or an application programming interface (API), which may include a predefined API.

Data extraction/mining module 228 and/or descriptor collector 230 may be configured to collect data regarding an item that is similar to and/or commercially competitive with an item 210.

Data extraction/mining module 228 and/or descriptor collector 230 may include a browser, crawling, and/or scraping application.

Data extraction/mining module 228 may be configured to mine data from one or more devices and/or accounts associated with a user. A user account may include, without limitation, a wish list, browsing history, an electronic message account (e.g., e-mail and/or text), a telephone account, a financial account (e.g., a bank account and/or user account with a vendor), and/or an account with a network-hosted service such an Internet-based social and/or professional networking service.

Data extraction/mining module 228 may be configured to identify a data source 204 to mine and/or to select from amongst multiple mining techniques based on a target.

A mining technique may be selected based on a device and/or device type, data type (e.g., text-based documents, photographs, and/or videos), data format, an account and/or account type, application through which data is accessible (e.g., a browser, other local application, and/or a web app), privacy constraints, usage goals including sharing/aggregating with others' data. A technique may be configurable with respect to user-specific security features, an application launch procedure, and/or an access sequence (e.g., sequence of web-based sites/pages and/or user selections therein).

Data may be mined for data related to items purchased by and/or of interests to a user, and or related to interests and/or preferences of the user (e.g., vegetarian, vegan, organic, kosher, halal, and/or allergies).

In FIG. 1, system 100 may include one or more storage devices and/or locations to store extracted data 109 and clustered items 116, keywords 120, and/or other data 121 (collectively referred to herein as data 115). Data 115 may further include data derived from data 111, keywords 120, and/or data 121, such as described in one or more examples herein.

Extracted data 109 may include indications of items of interest 110. Extracted data 109 may be stored in association with corresponding clustered items 116, and/or included as part of clustered items 116. Extracted data 109 and clustered items 116 may be collectively referred to herein as data 111.

Items 110, clusters 116, keywords 120, and/or data 121 may be presented to a user for review and/or modification (e.g., to rename clusters, move items amongst clusters 116, collapse or expand clusters 116, delete one or more items 110, and/or override a security setting/access level for one or more items within a cluster 116).

Extracted data 109, clustered items 116, keywords 120, and/or data 121 may include diverse objects or data structures, which may be challenging to manage and/or protect with a conventional pre-defined database structure. Data 115 or a portion thereof, may thus be stored in a datable for unstructured data (i.e., an unstructured data database), and system 100 may include one or more interfaces to search and/or access the unstructured data. Such an interface may include, without limitation, an HTTP client such as a browser-based interface.

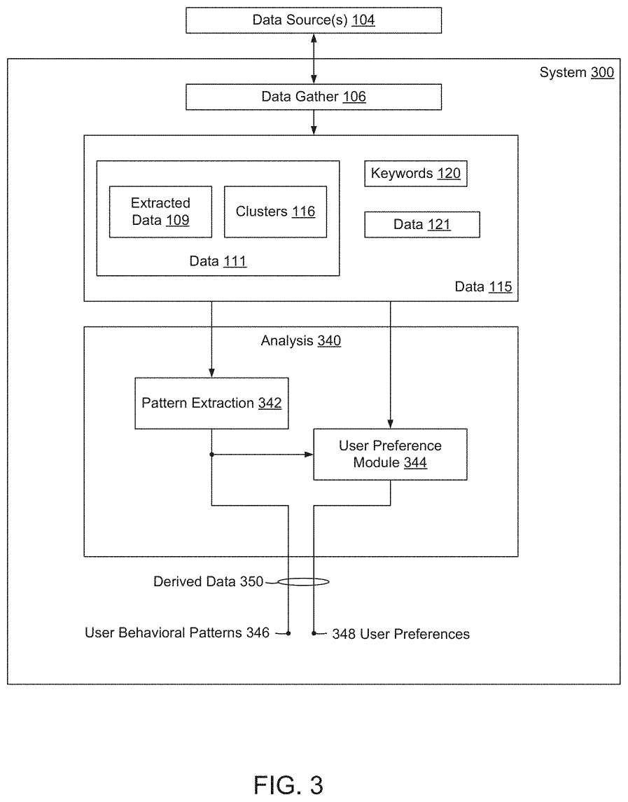

FIG. 3 is a block diagram of a system 300, including features described above with reference to FIG. 1, and further including an analysis module 340 to derive data 350 from data 115.

Analysis module 340 may include a pattern extraction and/or aggregation module, denoted here as pattern extraction module 342, to aggregated data and/or recognize user behavioral patterns 346, such as a shopping trait or pattern.

Pattern extraction module 342 may be configured to analyze features or values of extracted data 109 (including contextual data), clusters 116, and/or data 121, examples of which are provided in one or more examples above.

Pattern extraction module 342 may be configured to analyze 115 with respect to shopping trips of a user, and may be configured to analyze data 115 with respect to: travel route; driving pattern; schedule/calendar; sources visited; other individuals with prolonged contact with or in proximity; sequence in which sources are visited; items purchased at the visited sources; and/or an electronic shopping list of user A.

Pattern extraction module 342 is not, however, limited to the examples above.

Analysis module 220 may further include a user preference module 344 to determine (e.g., infer and/or predict) user preferences 348 based on data 115 (including prior shopping history data), user behavioral patterns 346, and/or data 121. User preference module 344 may be further configured to prioritize multiple user interests.

Detected behavioral patterns 236 and user interests 348 may be collectively referred to herein as derived data 350.

Example user interests are provided below for illustrative purposes. User preference module 344 is not, however, limited to the examples below.

User preference module 344 may be configured to determine a user preference based on and/or with respect to a feature or value of extracted data 109, a cluster 116, and/or contextual data, mined data 128, a shopping list, and/or a behavioral pattern 236. A context-based user preference may relate to geographic location or range, for example.

User preference module 344 may, for example, be configured to determine a user preference for an item in terms of vendor/store, brand, location, label, ingredients, quality, and/or cost, where cost may in terms of a list price and/or an applicable promotion, such as coupon, discount, credit, and/or customer reward program.

User preference module 344 may be configured to determine a shopping preference, which may relate to a travel route, time, location, budget, and/or sequence of sources to visit.

User preference module 344 may be further configured to infer or predict other data, such as availability data for an item and source.

User preference module 344 may be configured to infer user interests based on a combination of features, such as items purchased and sources visited on a shopping trip, including one or more of: sources visited during a shopping trip; purchase records of a shopping trip; sequence in which sources are visited during a shopping trip; contextual data for a window of time of the shopping trip; additional data obtained with respect to items purchased during the shopping trip; and/or a shopping pattern of user A.

As an example, availability data for an item on the shopping list of a potential subsequent shopper (e.g., inventory, relative price/cost, promotions and/or quality), may be inferred with respect to a source visited during a recent shopping trip based on purchase records of the visit to the source and/or purchase records of visits to other sources during the shopping trip.

User preference module 344 is not limited to the examples above.

Data 115 and/or derived data 350 may be useful in a variety of situations and/or applications, alone and/or in combination with one another, such as described in examples below. Systems and methods disclosed herein are not, however, limited to the examples below.

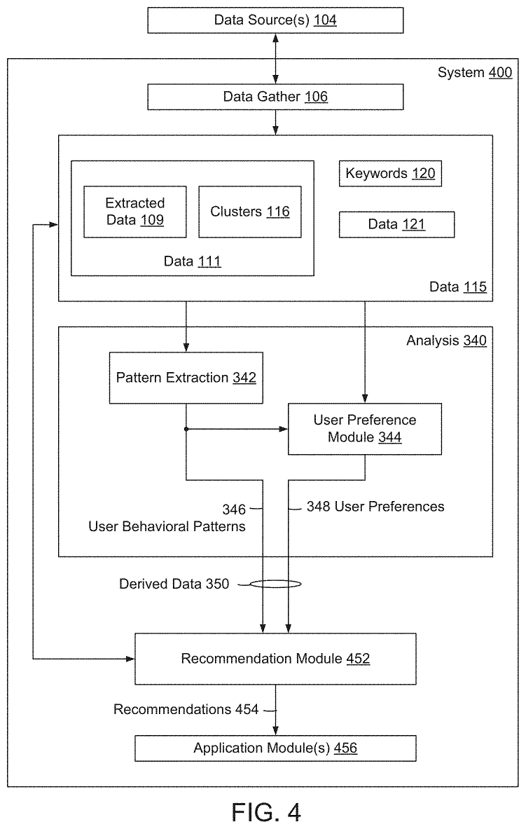

FIG. 4 is a block diagram of a system 400, including features described in one or more examples above, and further including a recommendation module 452 to provide user-specific recommendations 454 based on data 115 and/or derived data 350. A recommendation 454 may pertain to, without limitation, an item 110 and/or cluster 116. Recommendations 454 may be configured for, tailored to, and/or based on context and/or usage/application. For example, and without limitation, a recommendation 344 may be based in part on recent contextual data, such as geographic location of the user, weather, and/or traffic, in combination with user interests/preferences and/or behavioral patterns. Additional examples are provided further below.

System 400 may include an application module 456 to perform a function and/or provide service based on one or more recommendations 454. Application module 456 may include and/or represent an electronic and/or processor-based interface to receive recommendations 454 and/or derived data 350 and/or to interact with recommendation module 452 and/or analysis module 340.

Recommendation module 452 may be configured to access data 115 based on application module 456, such as to provide a recommendations 454 that is appropriate to a function or service of application module 456.

Application module 456 may represent one or multiple application modules, each of which may be configured to perform a corresponding function and/or provide a corresponding service. Recommendation module 452 may be configured to provide recommendations 454 to each of multiple application modules.

Alternatively, or additionally, recommendation module 452 and/or another recommendation module may be configured as an application-specific module to provide recommendations based on a function and/or service of a corresponding application module. An application specific recommendation module may be packaged and/or integrated with a corresponding application module. An application specific recommendation module may be configured to interface with a generic recommendation module and/or may be self-contained to provide recommendations based on derived data 350 and/or data 115.

System 400 may be user-configurable with respect to application module 456 and/or recommendation module 452, such as to permit a user to select from amongst multiple types of recommendations and/or application modules. System 400 may be configurable to add and/or remove applications analogous to that of a processor-based user device (e.g., computer, a smart-phone, and/or tablet device).

Data 115 may be combined with data of other users to provide crowd-sourced data (e.g., crowd-sourced shopping data), which may be accessible to each of the users and/or other entities. Data 115 may be anonymized prior to sharing by removing as much as any identifiable information and only answering questions to aggregated sets of data, or as little as only removing names of individuals and payment forms. Crowd-sourced data may provide a more robust global view and permit global optimizations with respect to user recommendations, such as user-specific shopping recommendations.

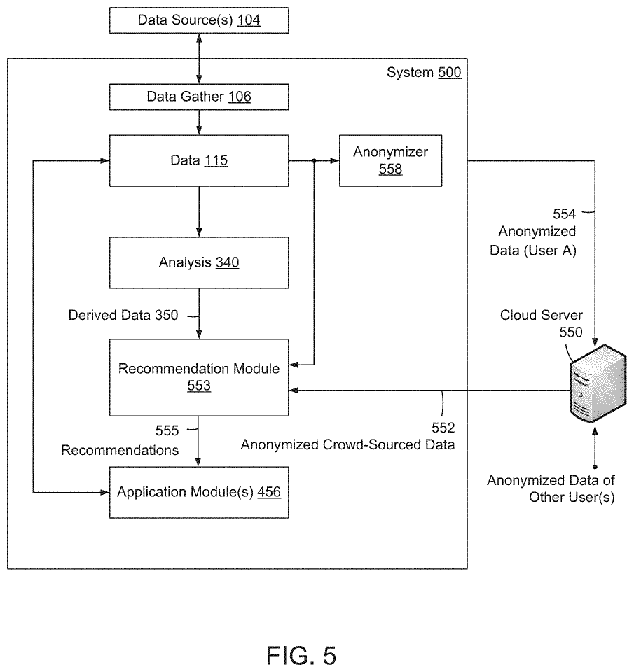

FIG. 5 is a block diagram of a system 500, including features described above, and further including a crowd-source system 550 to store and/or manage anonymized crowd-sourced data 552. Crowd-source system 550 may also be referred to herein as a cloud server 550.

Crowd-sourced data 552 may include anonymized data 554 of a user (denoted here as user A), and anonymized data of other users. Crowd-sourced data 552 may further include availability data (e.g., inventory, and/or pricing/cost data).

Crowd-sourced data 552 may provide users with access to a relatively expansive set of recent data points that encompass multiple categories of items and multiple sources of the items, which no one user could obtain on their own. Crowd-sourced data 552 may prove to be more accurate and/or reliable than data provided by individual sources.

Cloud server 550 may include an analysis module similar to analysis module 340 to identify behavioral patterns and/or user preference globally and/or based on one or more features, such as geographic region and/or other contextual data.

System 500 further includes a recommendation module 553 to provide recommendations 555 based on a combination of crowd-sourced data 552 and derived data 350 and/or data 115. Recommendation module 555 may, for example, recommend a particular source for an item of interest to user A in a situation where the source is selling the item in greater quantity than normal. Such a recommendation may be based on a determination and/or inference of availability, price, and/or promotion from crowd-sourced data 552.

Recommendation module 553 may be configured to query data 115 such as described above with respect to recommendation module 452. Recommendation module 553 may be further configured to query crowd-sourced data 552 in a similar manner.

System 500 further includes an anonymizer 548 to remove identification data from data 115 prior to sharing with cloud server 550. Anonymizer 558 may be dedicated for use by user A (i.e., a user device and/or user account), or shared amongst multiple users.

Anonymizer 558 may include an objective portion to identify and remove data that that is objectively specific to user A and/or other individual(s) and/or entities, such as personal or biographical data, names, contact data, birth dates, social security numbers, account numbers, user IDs, and/or passwords.

Anonymizer 558 may further include a subjective or contextual portion to identify and remove data that that may be used to identify a user depending context, also referred to herein as indirect identification. Anonymizer 558 may be configurable, or tunable, such as to permit expose more or less identification, and may be configurable based on contextual data, such as location, application querying and/or types of purchases.

A subjective filter may be useful where an application permits querying of crowd-sourced data 552 for behavioral patterns. For example, a query may be structured to search for purchases with a time frame or geographic area within which user A is one of a few individuals known to purchase the item, and possibly the only likely purchaser of the item. When user A is indirectly identified in such a way, additional queries may be structured around to identify interests, preferences, and/or behavioral (e.g., shopping) patterns of user A.

A subjective filter may be configured, for example, to remove spending habits from data 115 and/or to return null when results of a query would include data from less than a pre-determined number of other users.

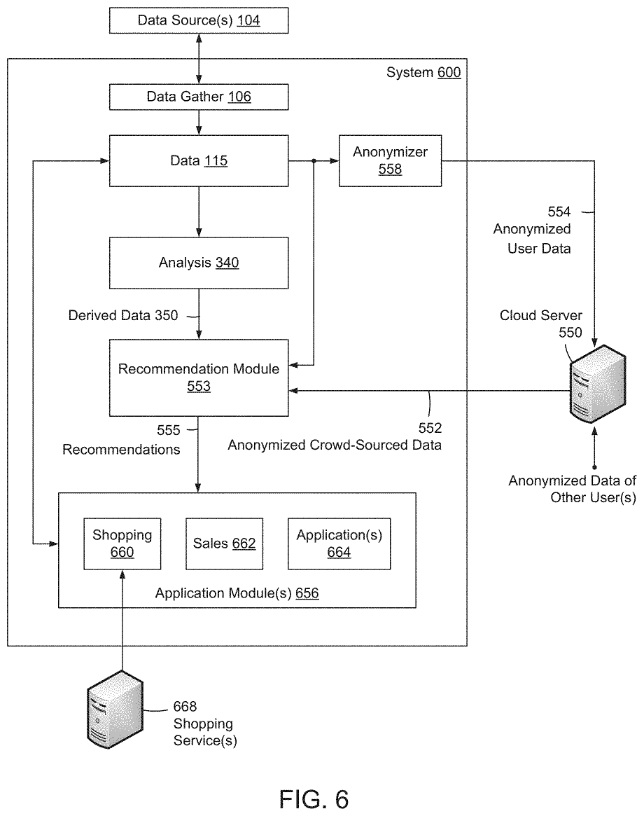

FIG. 6 is a block diagram of a system 600, including features described in one or more examples above, and further including an application module 656.

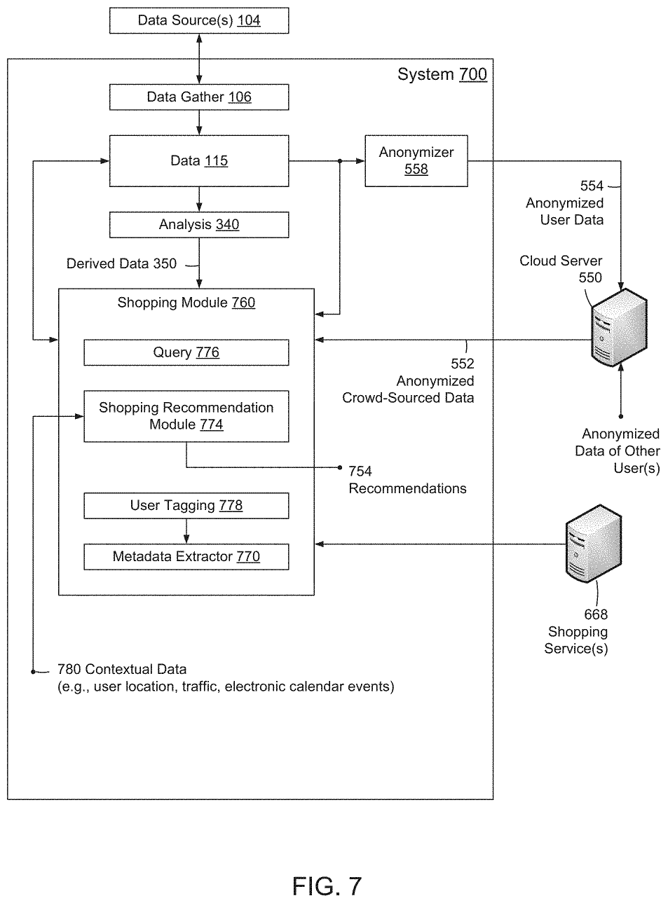

In FIG. 6, application module 656 includes a shopping application 660, a sales application 662, and one or more other applications 664. Application module 656 may include more than the illustrated application modules, fewer than the illustrated application modules, and/or different application modules. Shopping application 660 may be implemented as described below with reference to FIG. 7.

FIG. 7 is a block diagram of a system 700, including features described in one or more examples above, and further including a shopping application 760.

Shopping application 760 includes a shopping recommendation module 774 to provide shopping recommendations 754 to user A based on derived data 350 and/or crowd-sourced data 552. A shopping recommendation 754 may include, without limitation a shopping list of items, recommended sources (vendors and vendor locations) from which to purchase the items, recommended sequence in which to visit the sources, recommended travel route, and/or date and/or time to shop.

Recommendations 754 may be presented to through a display and/or other presentation system. Shopping application 760 may be configured to optimize recommendations 754 based on implicit and/or explicit user settings. The settings may relate to, without limitation, whether the user wants to minimize costs and/or time spent to meet all their shopping needs. The setting may permit the user to prioritize one setting relative to another.

Shopping application 760 may further include a tagging module 778 to permit a user to identify and/or select items of interest to the user. The act of identifying or selecting an item through an electronic or processor-based interface may be referred to herein as tagging. The tagging module may be configured to permit a user to tag items over multiple categories and/or from multiple sources, and may be configured to interface with a communication network, such as the Internet, to permit the user to browse and tag with respect to multiple potentially diverse sources or web sites. User tagging module 778 may also be referred to herein as an electronic shopping list module. Tagging could happen on a collection of devices and save the data and sync it among all of the devices.

Shopping application 760 may further include a metadata extractor 770 to extract metadata associated with tagged items. Alternatively, metadata extraction may be performed by data extraction/mining module 228 in FIG. 2. A tagged item and associated metadata may be added to data 115.

Shopping application 760 may further include a query module 776 to permit a user and/or another module of shopping application 760 to query crowd-sourced data 552, such as to identify shopping trends, behavioral patterns, and/or interests of other users. A query may be tailored to data associated with users having similar interests, behavioral patterns, and/or contextual data (e.g., geographic region). Query results may be used to optimize a shopping trip and/or a shopping list with respect to shopping or travel time, cost, and/or other features.

Shopping application 760 may be configured to interface with a shopping service 668, such as to access shopping data and/or to permit a user to purchase items from a source.

Returning to FIG. 6, sales application 662 may be configured to provide data regarding purchases and/or other transactions of user A to data 115, directly and/or through data gather module 106 in FIG. 1.

Sales application 662 may be configured to provide anonymized aggregated data regarding purchases and/or other user transactions of user A and/or other users to cloud server 550, for inclusion with crowd-sourced data 552.

Sales application 662 may be configured to permit a source (e.g., vendor, distributor, manufacture, producer, and/or service provider), and/or an end-user to query anonymized crowd-source data 552, such as to identify shopping trends, behavioral patterns, and/or user interests, which may be used to make recommendations to the source.

Sales application 662 may be configured to permit a source to submit data to cloud server 550 for inclusion with crowd-sourced data 552 (e.g., product/service line, inventory, prices, promotions, locations, and/or hours of operation).

Sales application 662 may permit a source to expose product and/or service lines on-line with little or no technical experience and/or financial outlay as long as consumers are purchasing these items from them. Sales module 662 may thus permit relatively small businesses to compete in the marketplace with an online presence with zero effort.

Application 664 in FIG. 6 may be configured to permit a 3^{rd} party to query data 115 and/or derived data 350. Application 664 may, for example, be configured to permit a financial planner to query data 115 and/or derived data 350 to identify spending habits or trends of user A. Application 664 may include an automated query module and/or a recommendation module to provide recommendations for user A to modify shopping behavior and/or spending habits.

Methods and systems disclosed herein may be configured to perform one or more of a variety of functions and/or to provide one or more of a variety of services, examples of which are provided below. Additional examples are provided below for illustrative purposes. Methods and systems disclosed herein are not limited to any of the examples below.

A method and/or system as disclosed herein may be configured to automatically read, catalog, and cluster e-mail receipts received by a user or consumer. Extracted pricing and usage data may be used to provide recommendations and/or obtain updates on items and/or categories of interest to the consumer.

Anonymized user data may be pushed to the cloud for sharing amongst like-minded consumers, such as to provide a more global view and global optimizations of individual goals when it comes to shopping. Anonymized cloud data may, for example, be queried for trends, and inventory data of stores.

User data and/or anonymized cloud data may be analyzed for trends/patterns and/or user interests, which may be provided to a learning algorithm to provide some a service to the user, such as a recommendation.

An analysis and/or query may be based on a domain and time frame, such as to determine where others purchase a particular time or combination of items.

An analysis and/or query may be structured for short-term or long-term cycles. Long term cycles can be used to identify seasonal items, and to match seasonal items deems of interest a user, based on market trends and/or prior user behavior.

A recommendation may include, for example, items to purchase during a shopping trip and/or times at which to schedule a shopping trip. For example, a pattern module may determine or infer that user A will need yogurt, orange juice, and cheese on a weekly basis. A recommendation module may recommend a corresponding weekly shopping list and/or a travel plan for the shopping trip. Another example could include the optimal price for an item and a probabilistic estimate of when to expert a source to offer the item at such a price.

A recommendation may relate to sources to visit during a shopping trip and/or a sequence at which to visit the sources.

A recommendation may relate to an item not previously purchased by the user.

A recommendation may seek to optimize a shopping trip and/or a shopping list based on travel time, costs, and/or other factors. A recommended shopping trip may balance and/or optimize multiple criteria deemed to be of interest to the user, such as minimization of travel distance, number of sources to visit, and/or cost. Costs may be determined based at least in part by looking up data on public sales sites and/or weekly advertisements.

Multiple applications having access to data infrastructure (e.g., user data and/or crowd-sourced data), may use the data infrastructure differently in order to optimize, share, and/or recall the data for the user. For example, when seeking the best deals with the fewest number of stores to visit, a shopping application may match items on a user shopping list with brands preferred by the user (e.g., based on prior purchase receipts of the user), and with online ads.

An anonymizer may be configured to remove identifiable data, including credit card, spending habits, and the like.

With crowd-sourced data, a user may have access to availability data of a source without having to visit or contact the source. This may benefit the user and the source.

Additional recommendation examples are provided below.

In an example, user A tags a particular item through a shopping application. If other users having the item on their shopping lists item on their shopping lists visit a particular source, but depart without the item listed on a purchase receipt of the source, there may be a relatively high probability that the item is out of stock or is not in a satisfactory condition at the source. In this example, a shopping application of user A may recommend another source for the item.

In another example, user A is interested in purchasing a particular item. An analysis of crowd-sourced data indicates that a particular source is selling the item at a volume that is exceptionally large for the time of the year. In this situation, current purchase prices for the source (available in the crowd-sourced data), may be compared to average prices for the item over preceding few weeks, months, or a similar time of year to determine whether the current price is exceptionally low. If so, a shopping application may recommend that the user purchase the item from the source.

In another example, user A is interested in a relatively high-price item (e.g., television, motorbike, or stroller), but is not sure how much to expect to pay for such an item. In this situation, crowd-sourced data may be queried to determine price ranges for multiple sources over multiple sales cycles, to determine an optimum time and source for purchasing the item.

In another example, crowd-sourced data is analyzed to detect data points that are well outside of a norm (i.e., outliers), such as a user who takes advantage of coupons to a much greater degree than others (i.e., an extreme couponer). Outlier data may be removed from crowd-sourced data, filtered prior to analysis, and/or filtered from query results. Outlier data may be useful in some situations.

In another example, a cost/benefit analysis is performed with respect to a membership or subscription, such as a membership with a big-box or high-volume store that carries a relatively broad line of goods. A cost-benefit analysis may determine whether membership is appropriate for a user based on purchasing habits and/or interests of the user.

In another example, an item is added to a user's shopping list based on a combination of factors. A seasonal item may be added, for example, based on a combination of shopping history of the user and recent local advertisements for the item, and/or recent purchases of the item others who have similar shopping patterns and/or interests of the user. The analysis may be limited to within a geographic region.

In another example, an item may be represented with a data object, which may be appended with additional data (e.g., as metadata) specific to a source of the item. The additional data may include data that is not available from the source, such as current availability data. Where user A is new to an area, for example, user A may not be aware that multiple categories of goods (e.g., tools, electronics, and groceries), are available from a single source. In this example, a shopping application may identify the source to the user, and/or may include the source is a shopping recommendation.

In the preceding example, if a preference of user A is to minimize time spent shopping, a shopping application may recommend the source, or may permit user A to prioritize cost with and shopping/travel time relative to one another. The latter permits user A to decide whether to potentially spend more time to save money.

A shopping application may be configured to interface with a map application on a user mobile device, such as to illustrate various shopping routes and corresponding costs. Shortest travel time and/or lowest cost options may be highlighted, which make account for traffic conditions, gas prices, and/or vehicle maintenance costs.

In another example, crowd-sourced data may be queried to identify other (anonymous) users with similar interests. The query may be based on purchases of items within a particular category by user A and the other users. After the other users are identified, another item within the category and/or within an adjacent category may be recommended to user A, if the item was previously purchased by the other users but not by user A.

In another example, a source may query its own data and/or crowd-sourced data to identify users that may be of particular importance to the source. The query may be configured to identify customer who frequently purchase from the source, and/or to identify influential or trendsetting users based on buying patterns. In this example, the buying pattern may relate to a product/service line of the source and/or other product/service lines. The source may target identified users, such with discounts/promotions and/or or other offers to interact with the source in new ways.

In another example, a source (e.g., manufacturer) may query crowd-sourced data to identify trends within categories associated with their product/service lines or brands, and/or within other categories. Such trends may help to identify potential changes in products/services and/or other market insight.

In another example, sales and/or sales volume of an item may be inferred with respect to a source. In another example, sales and/or sales volume of a source may be inferred.

In another example, a first source may query crowd-sourced data to identify items of interest to users. The crowd-sourced data may be further queried to identify a second source at which users purchase items of interest after departing the first source.

In another example, crowd-sourced data is queried for load balancing purposes, such as to identify various sources from which users purchase one or more items within a geographic range.

One or more features disclosed herein may be configured or implemented as/with circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof.

Information processing by software may be concretely realized by using hardware resources.

One or more features disclosed herein may be provided within a user platform or user device, a server system such as crowd server 550, other platform(s)/device(s), and combinations thereof.

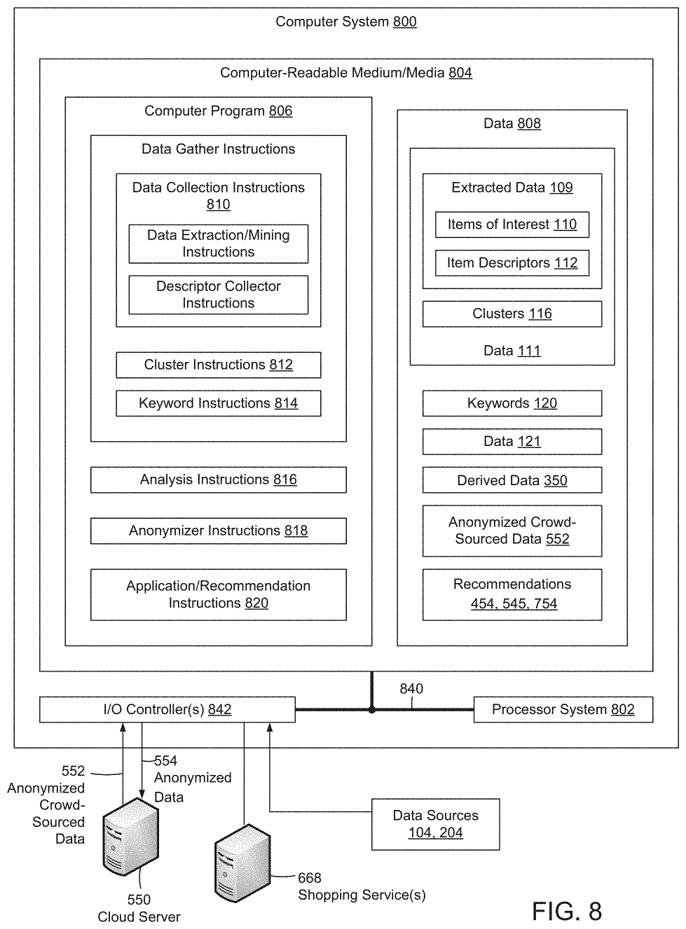

FIG. 8 is a block diagram of a computer system 800, configured to extract data from purchase records of a user, learn user purchasing behavior and user interests from the extracted data, and perform a user-specific function and/or provide a user-specific service based on the purchasing behavior and user interests.

Computer system 800, or a portion thereof, may represent an example embodiment or implementation of a system as described in one or more of FIGS. 1-7. Computer system 800 is not, however, limited the examples of any of FIGS. 1-7.

Computer system 800 includes one or more processors, illustrated here as a processor 802, to execute instructions of a computer program 806. Computer system 800 further includes a computer-readable medium or media (medium) 804.

Processor 802 may include one or more instruction processors and/or processor cores, and may further include a control unit to interface between the instruction processor(s)/core(s) and medium 804. Processor 802 may include, without limitation, one or more of a microprocessor, a graphics processor, a physics processor, a digital signal processor, a network processor, a front-end communications processor, a co-processor, a management engine (ME), a controller or microcontroller, a central processing unit (CPU), a general purpose instruction processor, an application-specific processor.

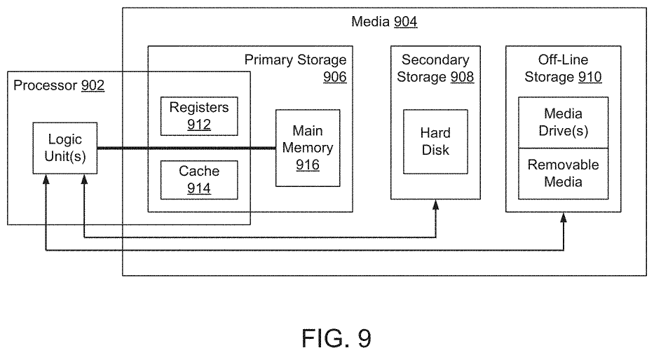

Medium 804 may include a non-transitory computer-readable medium, and may include one or more types of media disclosed below with reference to FIG. 9. Computer-readable medium 804 is not, however, limited to the examples of FIG. 9.

FIG. 9 is a block diagram of a processor 902 and computer-readable media 904. In FIG. 9, media 904 includes primary storage 906, secondary storage 908, and off-line storage 910.

Primary storage 906 includes registers 912, processor cache 914, and main memory or system memory 916. Registers 912 and cache 914 may be directly accessible by processor 902. Main memory 916 may be accessible to processor 902 directly and/or indirectly through a memory bus. Primary storage 906 may include volatile memory such as random-access memory (RAM) and variations thereof including, without limitation, static RAM (SRAM) and/or dynamic RAM (DRAM).

Secondary storage 908 may be indirectly accessible to processor 902 through an input/output (I/O) channel, and may include non-volatile memory such as read-only memory (ROM) and variations thereof including, without limitation, programmable ROM (PROM), erasable PROM (EPROM), and electrically erasable PROM (EEPROM). Non-volatile memory may also include non-volatile RAM (NVRAM) such as flash memory. Secondary storage 908 may be configured as a mass storage device, such as a hard disk or hard drive, a flash memory drive, stick, or key, a floppy disk, and/or a zip drive.

Off-line storage 910 may include a physical device driver and an associated removable storage medium, such as an optical disc.

In FIG. 8, media 804 includes a computer program encoded 806 encoded therein, including instructions to be executed by processor 802. Computer-readable medium 804 further includes data 808, which may be used by processor 802 during execution of computer program 806 and/or generated by processor 802 during execution of computer program 806.

Computer program 806 includes data collection instructions 810 to cause processor 802 to extract data from one or more data sources, identify items of interest 110 from the extracted data, and retrieve item descriptors 112 for items 110 (collectively referred to herein as extracted data 109), such as described above with respect to data collection module 108 in FIG. 1 and/or FIG. 2.

Computer program 806 further includes cluster instructions 812 to cause processor 802 to cluster items 110 based on corresponding item descriptors 112 to provide clusters of items (clusters) 116, such as described above with respect to cluster module 114 in FIG. 1.

Computer program 806 further includes keyword instructions 814 to cause processor 802 to assign, associate, and/or append a set of one or more tags or keywords 120 to each cluster 116, such as described above with respect to keyword assignment module 118 in FIG. 1.

Computer program 806 further includes analysis instructions 816 to cause processor 802 to derive data 350 from extracted data 109 and/or clusters 116 (collectively referred to herein as data 111), and/or keywords 120, such as described above with respect to analysis module 340 in FIG. 2.

Computer program 806 further includes anonymizer instructions 818 to cause processor 802 to remove personal identification data from data 111 and provide corresponding anonymous data 554 to cloud server 550, such as described in one or more examples above.

Computer program 806 includes user application and/or recommendation instructions 820 to cause processor 802 to perform and/or provide one or more functions and/or services based on data 111, derived data 350, and/or anonymized crowd-sourced data 552, such as described in one or more examples above.

Computer system 800 may include communications infrastructure 840 to communicate amongst devices and/or resources of computer system 800.

Computer system 800 may include one or more input/output (I/O) devices and/or controllers 842 to interface with one or more other systems, such cloud server 550, data sources 102 and/or 204, and/or shopping service(s) 668, such as described in one or more examples above.

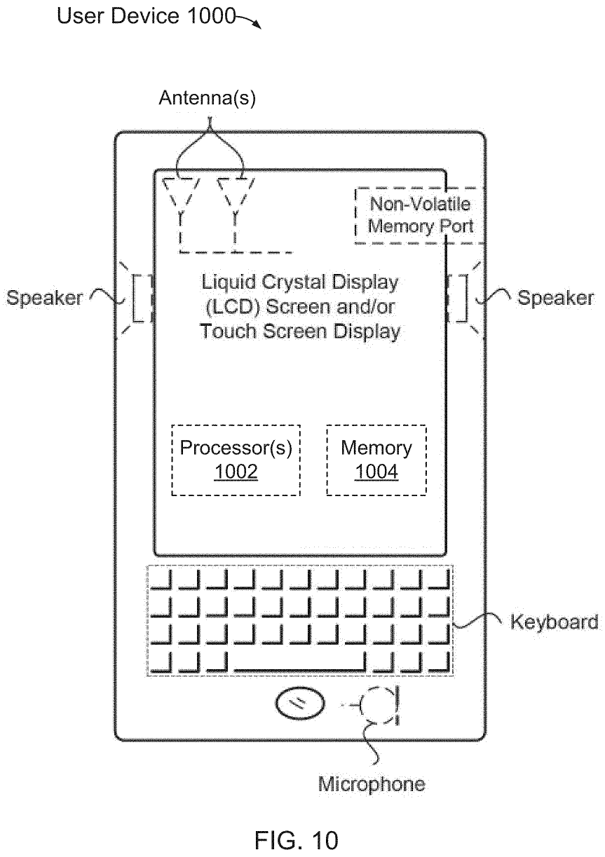

Methods and systems disclosed herein may be implemented with respect to one or more of a variety of systems and/or devices, an example of which is provided below with reference to FIG. 10. Methods and systems disclosed herein are not, however, limited to the examples of FIG. 10.

FIG. 10 is an illustration of a user device 1000, including a processor 1002 and associated memory, cache, and/or other computer-readable medium, illustrated here as memory 1004.

Device 1000 further includes a user interface, illustrated here as including a display, a keyboard, speakers, and a microphone. Device 1000 may include other interface devices such as, without limitation, a cursor device, a touch-sensitive device, a motion and/or image sensor, and/or a virtual keyboard on the display.

Device 1000 further includes a communication wireless communication system to communicate with an external communication network external network, which may include a packet-based network (e.g., a proprietary network and/or the Internet), and/or a voice network (e.g., a wireless telephone network).

Device 1000 may be configured as a portable/hand-held device, such as a mobile telephone or smart-phone and/or a computer system such as a laptop, notebook, net-book, note-pad, and/or tablet system, and/or other conventional and/or future-developed device(s). System 1000 may also be configured as a non-mobile device, such as desktop computer, a set-top box, and/or a gaming device. System 1000 is not, however, limited to these examples.

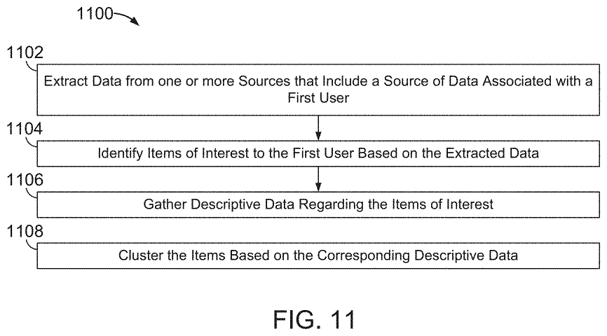

FIG. 11 is a flowchart of a method 1100 of analyzing shopping history of a user.

At 1102, data is extracted from one or more data sources that include a source of data associated with a user. The data associated with the user may include shopping data, such as computer-readable purchase records that pertain to multiple purchase sources and multiple subject matters of the user. The extracting may be performed as described above with respect to data collection module 108 (FIG. 1) and/or data collection module 208 (FIG. 2).

At 1104, items of interest to the first user are identified based on the extracted data.

At 1106, descriptive data regarding the items of interest is gathered.

At 1108, the items of interest to the user are clustered into groups of items based on the corresponding descriptive data, wherein discriminating features of the clusters are indicative of interests of the users.

Method 1100 may further include one or more features described in one or more examples further below.

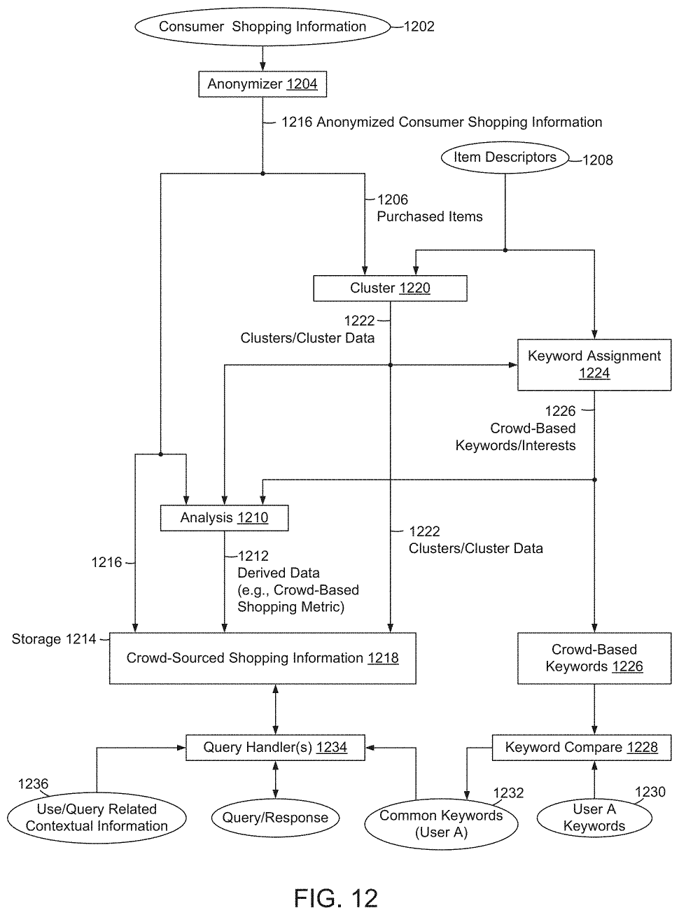

FIG. 12 is a block diagram of a system 1200 to organize and selectively disclose crowd-sourced shopping information based on contextual relations.

System 1200, or a portion thereof, may correspond to a crowd-source system or cloud server, such as described in one or more examples above with respect to cloud server 550. A portion of system 1200 may correspond to a user application, such as described in one or more examples herein.

System 1200 includes an anonymizer 1204 to receive and anonymize consumer shopping information 1202. Consumer shopping information 1202 includes purchasing information, including indications of items 1206 purchased by the consumers and corresponding metadata, or item descriptors 1208.

Item descriptors 1208 may be provided by consumer devices and/or consumer applications, and/or may be retrieved from one or more data sources, such as described in one or more examples herein.

System 1200 further includes an analysis module 1210 to derive data 1212 from the shopping information of at least a subset of the consumers. Derived data 1212 may include a crowd-based shopping metric, such as described in one or more examples herein.

System 1200 further includes storage 1214 to hold anonymized consumer shopping information 1216 and derived data 1212 as crowd-sourced shopping information 1218. Storage 1214 may include a centralized and/or distributed storage system, and may include a database and/or database server.

System 1200 further includes a cluster module 1220 to group items 1206 purchased by the consumers into clusters 1222 based on relatedness of the items. Relatedness of items 1206 may be determined from item descriptors 1208.

System 1200 further includes a keyword assignment module 1224 to assign a crowd-based keyword 1226 to each group of items or cluster 1222. Each group or cluster 1222 and associated keyword represents a crowd-based interest.

System 1200 further includes a keyword compare module 1228 to compare the crowd-based keywords 1226 to a set of one or more keywords associated with each of multiple users to identify a set of one or more common keywords for each user. In FIG. 12, a set of one or more common keywords 1232 are identified for a user A based on a set of one or more keywords 1230 associated with user A.

System 1200 further includes a query handler 1234 to disclose a portion of crowd-sourced shopping information 1218 to user A if the portion relates to a common keyword 1232 associated with user A.

Query handler 1234 may be configured to respond to queries from user A based on common keywords 1232. A query may be submitted and responded to via a user application, which may run on a user device, a server system (e.g., a web application), and combinations thereof. A query may be composed by the user and/or by the user application. Query handler 1234 may be configured to consider contextual information 1236 in responding to a query.

The following examples pertain to further embodiments.

An Example 1 is a method of organizing and selectively disclosing crowd-sourced shopping information based on a contextual relation between the crowd-sourced shopping information and a user, including: receiving shopping information of consumers, including information extracted from computer-readable purchase records of the consumers; deriving a metric from the shopping information of at least a subset of the consumers, including one or more of deriving a crowd-based shopping behavioral pattern, deriving a crowd-based shopping preference, deriving a shopping trend, inferring availability information for an item, and inferring a sales promotion; identifying items purchased by the consumers, and grouping the items based on relatedness of the items; assigning a crowd-based keyword to each group of items, where each keyword represents a crowd-based interest; comparing the crowd-based keywords to keywords associated with each of multiple users to identify a set of one or more common keywords for each user; identifying crowd-sourced shopping information that relates to a common keyword of a user, where the crowd-sourced shopping information includes the shopping information of the consumers and the metric; and disclosing the identified crowd-sourced shopping information to the user.

In an Example 2, the metric is derived with respect to one or more of an item, an item descriptor, a purchase source, a purchase location, a purchase date, a purchase time, a purchase price, a form of payment, a source of payment funds, a purchase promotion under which an item is purchased, item metadata, item label data, item branding data, item ingredients, and item certification.

In an Example 3, Example 1 or Example 2 include deriving the metric with respect to contextual shopping information of the consumers, and the contextual shopping information includes one or more of a shopping trip during which an item is purchased, other items purchased during the shopping trip, consumer shopping lists, sources visited during shopping trips, travel routes of shopping trips, sequence in which sources are visited during shopping trips, items purchased at each source visited during shopping trips, frequency of purchases of an item, combinations of items purchased during shopping trips, combinations of items purchased at a source, times of shopping trips, a geographic area of a purchase, traffic information within the geographic area and a time window of the purchase, weather information for the geographic area within the time window, a consumer-calendared event within the time window, and a public event within a time window.

In an Example 4, the deriving a metric of any preceding Example includes deriving availability information with respect to a vendor, and where the availability information includes one or more of types of items available from the vendor, inventory count of an item available from the vendor, and cost of an item available from the source, the cost of an item includes one or more of a price of the item and a purchase incentive applicable to the item, and the purchase incentive includes one or more of a coupon, a discount, a credit, and a customer reward.

In an Example 5, the deriving a metric of any preceding Example includes determining types of items available from a vendor based on electronic purchase records of consumers.

In an Example 6, the deriving a metric of any preceding Example includes inferring availability information of a first item with respect to a first vendor based on electronic consumer shopping lists that include the first item, electronic records of items purchased by the respective consumers from the first vendor, and electronic records of items purchased by the respective consumers from one or more other vendors subsequent to visits to the first vendor.

In an Example 7, the deriving a metric of Example 6 further includes inferring that a second item is an alternative to the first item based on the electronic consumer shopping lists and the electronic records of items purchased by the respective consumers from the first vendor and the one or more other vendors.

In an Example 8, the deriving a metric of any preceding Example includes deriving a cyclical trend with respect to one or more of a purchase price of an item, a purchase incentive for the item, and inventory of the item.

In an Example 8, the deriving a metric of any preceding Example includes evaluating consumer purchases from a vendor over time to identify a change in a volume of the purchases, and inferring a sales promotion based on an extent of the change in the volume of purchases.

In an Example 10, any preceding Example further includes anonymizing the crowd-sourced shopping information, including removing personal identification information and account information from the shopping information of the consumers, and filtering the crowd-sourced shopping information disclosed to the user to preclude identification of a consumer from the crowd-sourced shopping information disclosed to the user.

In an Example 11, the user in any preceding Example is a consumer and the set of one or more keywords associated with the user represent types of items interests of the consumer.

In an Example 12, Example 11 further includes extracting information related to the consumer from one or more data sources that include a source of computer-readable purchase records of the consumer, identifying items of interest to the consumer based on the extracted information, grouping the identified items of interest to the consumer based on relatedness of the items, and associating a keyword with each group of items of interest to the consumer, where the keywords of the consumer represent the respective types of items of interest of the consumer.

In an Example 13, Example 12 further includes generating a shopping recommendation for the consumer based on the items of interest to the consumer and one or more of a behavioral pattern of the consumer derived from the extracted information related to the consumer, a shopping preference of the consumer derived from one or more of the extracted information related to the consumer and the consumer behavioral pattern, contextual information associated with purchases by the consumer; and crowd-sourced shopping information disclosed to the consumer.

In an Example 14, the generating a shopping recommendation includes generating a shopping list of items to purchase, and generating an itinerary for a shopping trip to purchase items of the shopping list, where the itinerary includes one or more of, sources at which to buy items of the shopping list, a sequence in which to visit the sources during the shopping trip, a travel route for the shopping trip, and a scheduled time for the shopping trip.

In an Example 15, the generating the itinerary includes generating the itinerary based on multiple shopping preferences of the consumer that include one or more of minimizing driving time, minimizing number of sources to visit during the shopping trip, minimizing travel distance, and minimizing costs.

In an Example 16, any one of Examples 11 through 15 further include identifying an item purchased by one or more other consumers as an item of interest to the consumer if the item relates to a common keyword of the consumer, and recommending the identified item to the consumer as an item of interest to the consumer.

In an Example 17, the user of any one of Examples 1-10 is a vendor, the set of one or more keywords associated with the user correspond to types of items available from the vendor, the deriving a metric includes deriving the metric based on consumer purchases of an item that is available from the vendor, and the disclosing includes disclosing the metric to the vendor.

In an Example 18, the deriving a metric of Example 17 includes one or more of deriving the metric based on purchases of a first item from the vendor, deriving the metric based on purchases of the first item from one or more other vendors, and deriving the metric based on purchases of other items by consumers who purchased the first item.

An Example 19 is a method of organizing and presenting user information based on contextual relations, including extracting information from one or more of a user device, a user account, and computer-readable purchase records of the user, identifying items of interest to the user from the extracted information, retrieving descriptors of the items, grouping the items based on relatedness of the descriptors, associating keywords with the groups of items, where each group of items and corresponding keyword represents a corresponding interest of the user, configuring a browser interface with a tabbed page for each of the keywords, and providing access to extracted information associated with each of the user interests through the corresponding tabbed page of the browser interface.

An Example 20 is an apparatus configured to perform the method of any one of Examples 1-18.

An Example 21 is an apparatus comprising means for performing the method of any one of Examples 1-18.

An Example 22 is a computer system to perform the method of any of Examples 1-18.

An Example 23 is a communications device arranged to perform the method of any one of Examples 1-18.

An Example 24 is a computing device that includes a chipset according to any one of Examples 1-18.

An Example 25 is a processor and memory configured to perform the method of any one of Examples 1-18. In an Example 26, the Example 25 further includes a user interface and a communication system to interface with a communication network and one or more of the processor and the user interface.

An Example 26 is a system to organize and selectively disclose crowd-sourced shopping information based on a contextual relation between the crowd-sourced shopping information and a user, including: a crowd-source server to receive shopping information of consumers, including information extracted from computer-readable purchase records of the consumers; an analysis module to derive a metric from the shopping information of at least a subset of the consumers, where the metric includes one or more of a crowd-based shopping behavioral pattern, a crowd-based shopping preference, a shopping trend, availability information for an item, and a sales promotion; a cluster module to group items purchased by the consumers based on relatedness of the items; a keyword assignment module to assign a crowd-based keyword to each group of items, where each keyword represents a crowd-based interest; a keyword compare module to compare the crowd-based keywords to keywords associated with each of multiple users to identify a set of one or more common keywords for each user; and a query module to identify crowd-sourced shopping information that relates to a common keyword of a user and to disclose the identified crowd-sourced shopping information to the user, where the crowd-sourced shopping information includes the shopping information of the consumers and the metric.

In an Example 27, the analysis module is configured to derive the metric with respect to one or more of an item, an item descriptor, a purchase source, a purchase location, a purchase date, a purchase time, a purchase price, a form of payment, a source of payment funds, a purchase promotion under which an item is purchased, item metadata, item label data, item branding data, item ingredients, and item certification.

In an Example 28, the analysis module of Example 26 or 27 is configured to derive the metric with respect to contextual shopping information of the consumers, and the contextual shopping information includes one or more of, a shopping trip during which an item is purchased, other items purchased during the shopping trip, consumer shopping lists, sources visited during shopping trips, travel routes of shopping trips, sequence in which sources are visited during shopping trips, items purchased at each source visited during shopping trips, frequency of purchases of an item, combinations of items purchased during shopping trips, combinations of items purchased at a source, times of shopping trips, a geographic area of a purchase, traffic information within the geographic area and a time window of the purchase, weather information for the geographic area within the time window, a consumer-calendared event within the time window, and a public event within a time window.

In an Example 29, the analysis module of any one of Examples 26-28 is configured to derive availability information with respect to a vendor, the availability information includes one or more of types of items available from the vendor, inventory count of an item available from the vendor, and cost of an item available from the source, the cost of an item includes one or more of a price of the item and a purchase incentive applicable to the item, and the purchase incentive includes one or more of a coupon, a discount, a credit, and a customer reward.

In an Example 30, the analysis module of any one of Examples 26-29 is configured to determine types of items available from a vendor based on electronic purchase records of consumers.

In an Example 31, the analysis module of Example 30 is configured to infer availability information of a first item with respect to a first vendor based on electronic consumer shopping lists that include the first item, electronic records of items purchased by the respective consumers from the first vendor, and electronic records of items purchased by the respective consumers from one or more other vendors subsequent to visits to the first vendor.

In an Example 32, the analysis module of Example 31 is further configured to infer that a second item is an alternative to the first item based on the electronic consumer shopping lists and the electronic records of items purchased by the respective consumers from the first vendor and the one or more other vendors.

In an Example 33, the analysis module of any one of Examples 26-32 is configured to derive a cyclical trend with respect to one or more of a purchase price of an item, a purchase incentive for the item, and inventory of the item.

In an Example 34, the analysis module of any one of Examples 26-33 is configured to evaluate consumer purchases from a vendor over time to identify a change in a volume of the purchases, and to infer a sales promotion based on an extent of the change in the volume of purchases.

In an Example 35, the system of any one of Examples 26-34 further includes an anonymizer module to anonymize the crowd-sourced shopping information, including to remove personal identification information and account information from the shopping information of the consumers, and filter the crowd-sourced shopping information disclosed to the user to preclude identification of a consumer from the crowd-sourced shopping information disclosed to the user.

In an Example 36, the user of any one of Examples 26-35 is a consumer and the set of one or more keywords associated with the user represent types of items interests of the consumer.

In an Example 37, the system of Example 36 further includes: a data collection module to extract information related to the consumer from one or more data sources that include a source of computer-readable purchase records of the consumer, and to identify items of interest to the consumer based on the extracted information; a cluster module to group the identified items of interest to the consumer based on relatedness of the items; and a keyword assignment module to associate a keyword with each group of items of interest to the consumer, where the keywords of the consumer represent the respective types of items of interest of the consumer.

In an Example 38, the system of Example 37 further includes a shopping module to generate a shopping recommendation for the consumer based on the items of interest to the consumer and one or more of a behavioral pattern of the consumer derived from the extracted information related to the consumer, a shopping preference of the consumer derived from one or more of the extracted information related to the consumer and the consumer behavioral pattern, contextual information associated with purchases by the consumer; and crowd-sourced shopping information disclosed to the consumer.

In an Example 39, the shopping module is configured to generate the shopping recommendation to include a shopping list of items to purchase and an itinerary for a shopping trip to purchase items of the shopping list, where the itinerary includes one or more of, sources at which to buy items of the shopping list, a sequence in which to visit the sources during the shopping trip, a travel route for the shopping trip, and a scheduled time for the shopping trip.

In an Example 40, the shopping module is configured to generate the itinerary based on multiple shopping preferences of the consumer that include one or more of minimize driving time, minimize number of sources to visit during the shopping trip, minimize travel distance, and minimize costs.

In an Example 41, the analysis module of any one of Examples 36-40 is configured to identify an item purchased by one or more other consumers as an item of interest to the consumer if the item relates to a common keyword of the consumer, and recommend the identified item to the consumer as an item of interest to the consumer.

In an Example 42, the user in any one of Examples 26-35 is a vendor, the set of one or more keywords associated with the user correspond to types of items available from the vendor, the analysis module is configured to derive the metric based on consumer purchases of an item that is available from the vendor, and the query module is configured to disclose the metric to the vendor.

In an Example 43, the analysis module of Example 42 is configured to derive the metric based on one or more of purchases of a first item from the vendor, purchases of the first item from one or more other vendors, and purchases of other items by consumers who purchased the first item.

An Example 44 is a non-transitory computer readable medium encoded with a computer program, including instructions to cause a processor to: receive shopping information of consumers, including information extracted from computer-readable purchase records of the consumers; derive a metric from the shopping information of at least a subset of the consumers, where the metric includes one or more of a crowd-based shopping behavioral pattern, a crowd-based shopping preference, a shopping trend, availability information for an item, and a sales promotion; identify items purchased by the consumers based on the shopping information of the consumers; group the items purchased by the consumers based on relatedness of the items; assign a crowd-based keyword to each group of items, where each keyword represents a crowd-based interest; compare the crowd-based keywords to keywords associated with each of multiple users to identify a set of one or more common keywords for each user; and identify crowd-sourced shopping information that relates to a common keyword of a user and disclose the identified crowd-sourced shopping information to the user, where the crowd-sourced shopping information includes the shopping information of the consumers and the metric.

In an Example 45, the instructions further include instructions to cause the processor to derive the metric with respect to one or more of an item, an item descriptor, a purchase source, a purchase location, a purchase date, a purchase time, a purchase price, a form of payment, a source of payment funds, a purchase promotion under which an item is purchased, item metadata, item label data, item branding data, item ingredients, and item certification.

In an Example 46, the instructions of Example 44 or Example 45 further include instructions to cause the processor to derive the metric with respect to contextual shopping information of the consumers, where the contextual shopping information includes one or more of, a shopping trip during which an item is purchased, other items purchased during the shopping trip, consumer shopping lists, sources visited during shopping trips, travel routes of shopping trips, sequence in which sources are visited during shopping trips, items purchased at each source visited during shopping trips, frequency of purchases of an item, combinations of items purchased during shopping trips, combinations of items purchased at a source, times of shopping trips, a geographic area of a purchase, traffic information within the geographic area and a time window of the purchase, weather information for the geographic area within the time window, a consumer-calendared event within the time window, and a public event within a time window.

In an Example 47, the instructions of any one of Examples 44 to 46 further include instructions to cause the processor to derive availability information with respect to a vendor, where the availability information includes one or more of types of items available from the vendor, inventory count of an item available from the vendor, and cost of an item available from the source, the cost of an item includes one or more of a price of the item and a purchase incentive applicable to the item, and the purchase incentive includes one or more of a coupon, a discount, a credit, and a customer reward.

In an Example 48, the instructions of any one of Examples 44 to 47 further include instructions to cause the processor to determine types of items available from a vendor based on electronic purchase records of consumers.

In an Example 49, the instructions of any one of Examples 44 to 48 further include instructions to cause the processor to infer availability information of a first item with respect to a first vendor based on electronic consumer shopping lists that include the first item, electronic records of items purchased by the respective consumers from the first vendor, and electronic records of items purchased by the respective consumers from one or more other vendors subsequent to visits to the first vendor.

In an Example 50, the instructions of Example 49 further includes instructions to cause the processor to infer that a second item is an alternative to the first item based on the electronic consumer shopping lists and the electronic records of items purchased by the respective consumers from the first vendor and the one or more other vendors.

In an Example 51, the instructions of any one of Examples 44 to 50 further include instructions to cause the processor to derive a cyclical trend with respect to one or more of a purchase price of an item, a purchase incentive for the item, and inventory of the item.

In an Example 52, the instructions of any one of Examples 44 to 51 further include instructions to cause the processor to evaluate consumer purchases from a vendor over time to identify a change in a volume of the purchases, and to infer a sales promotion based on an extent of the change in the volume of purchases.

In an Example 53, the instructions of any one of Examples 44 to 52 further include instructions to cause the processor to anonymize the crowd-sourced shopping information, including to remove personal identification information and account information from the shopping information of the consumers, and filter the crowd-sourced shopping information disclosed to the user to preclude identification of a consumer from the crowd-sourced shopping information disclosed to the user.

In an Example 54, the user of any one of Examples 44 to 53 is a consumer and the set of one or more keywords associated with the user represent types of items interests of the consumer.

In an Example 55, the instructions of Example 54 includes instructions to cause the processor to extract information related to the consumer from one or more data sources that include a source of computer-readable purchase records of the consumer, and identify items of interest to the consumer based on the extracted information, group the items of interest to the consumer based on relatedness of the items, and associate a keyword with each group of items of interest to the consumer, where the keywords of the consumer represent the respective types of items of interest of the consumer.

In an Example 56, the instructions of Example 54 or 55 further include instructions to cause the processor to generate a shopping recommendation for the consumer based on the items of interest to the consumer and one or more of, a behavioral pattern of the consumer derived from the extracted information related to the consumer, a shopping preference of the consumer derived from one or more of the extracted information related to the consumer and the consumer behavioral pattern, contextual information associated with purchases by the consumer; and crowd-sourced shopping information disclosed to the consumer.

In an Example 57, the instructions of Example 56 further includes instructions to cause the processor to generate the shopping recommendation to include a shopping list of items to purchase and an itinerary for a shopping trip to purchase items of the shopping list, and the itinerary includes one or more of sources at which to buy items of the shopping list, a sequence in which to visit the sources during the shopping trip, a travel route for the shopping trip, and a scheduled time for the shopping trip.

In an Example 58, the instructions of Example 57 further includes instructions to cause the processor to generate the itinerary based on multiple shopping preferences of the consumer that include one or more of, minimize driving time, minimize number of sources to visit during the shopping trip, minimize travel distance, and minimize costs.

In an Example 59, the instructions of any one of Examples 54 to 58 further include instructions to cause the processor to identify an item purchased by one or more other consumers as an item of interest to the consumer if the item relates to a common keyword of the consumer, and recommend the identified item to the consumer as an item of interest to the consumer.

In an Example 60, the user of any one of Examples 44 to 53 is a vendor, the set of one or more keywords associated with the user correspond to types of items available from the vendor, and the instructions include instructions to cause the processor to derive the metric based on consumer purchases of an item that is available from the vendor and disclose the metric to the vendor.

In an Example 61, the instructions of Example 60 further include instructions to cause the processor to derive the metric based on one or more of, purchases of a first item from the vendor, purchases of the first item from one or more other vendors, and purchases of other items by consumers who purchased the first item.

An Example 62 is a method of organizing and selectively disclosing crowd-sourced shopping information based on contextual relations, including: receiving shopping information of consumers, including information extracted from computer-readable purchase records of the consumers; deriving a crowd-based shopping metric from the shopping information of at least a subset of the consumers; combining the shopping information and the shopping metric as crowd-sourced shopping information; grouping items purchased by the consumers based on relatedness of the items; assigning a crowd-based keyword to each group of items, where each group of items and associated keyword represents a crowd-based interest; comparing the crowd-based keywords to keywords associated with each of multiple users to identify a set of one or more common keywords for each user; and disclosing a portion of the crowd-sourced shopping information to a user if the portion relates to a common keyword of the user.

An Example 63 is a system to organize and selectively disclose crowd-sourced shopping information based on contextual relations, including: a crowd-source database to receive shopping information of multiple consumers; an analysis module to derive a crowd-based shopping metric from the shopping information of at least a subset of the consumers; where the crowd-source database is configured to store the shopping information and the shopping metric as crowd-sourced shopping information; a cluster module to group items purchased by the consumers based on relatedness of the items; a keyword assignment module to assign a crowd-based keyword to each group of items, where each group of items and associated keyword represents a crowd-based interest; a keyword compare module to compare the crowd-based keywords to keywords associated with each of multiple users to identify a set of one or more common keywords for each user; and a query handler to disclose a portion of the crowd-sourced shopping information to a user if the portion relates to a common keyword of the user.

An Example 64 is a non-transitory computer-readable medium encoded with a computer program, including instructions to cause a processor to: receive shopping information of consumers; derive a crowd-based shopping metric from the shopping information of at least a subset of the consumers; combine the shopping information and the shopping metric as crowd-sourced shopping information; group items purchased by the consumers based on relatedness of the items; assign a crowd-based keyword to each group of items, where each group of items and associated keyword represents a crowd-based interest; compare the crowd-based keywords to keywords associated with each of multiple users to identify a set of one or more common keywords for each user; and disclose a portion of the crowd-sourced shopping information to a user if the portion relates to a common keyword of the user.

An Example 65 is a system to organize and present user information based on contextual relations, including: a data collection system to extract information from one or more of a user device, a user account, and computer-readable purchase records of the user, identifying items of interest to the user from the extracted information, and retrieve descriptors of the items; a cluster module to group the items based on relatedness of the descriptors; a keyword assignment module to associate keywords with the groups of items, where each group of items and corresponding keyword represents a corresponding one of the interests of the user; and a tabbed browser interface to provide access to extracted information associated with each of the user interests through corresponding tabbed pages of the browser.

An Example 66 is a non-transitory computer-readable medium encoded with a computer program, including instructions to cause a processor to: extract information from one or more of a user device, a user account, and computer-readable purchase records of the user; identify items of interest to the user from the extracted information; retrieve descriptors of the items; group the items based on relatedness of the descriptors; associate keywords with the groups of items, where each group of items and corresponding keyword represents a corresponding interest of the user; configure a browser interface with a tabbed page for each of the keywords; and provide access to extracted information associated with each of the user interests through the corresponding tabbed page of the browser interface.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A method, comprising:
extracting shopping information of a subset of a plurality of consumers from a plurality of electronic receipts of the subset of consumers;
anonymizing the shopping information of the consumers extracted from the plurality of electronic receipts of the subset of consumers, including first removing shopping information data that are objectively specific to individual ones of the subset of consumers, and second removing shopping information data that can subjectively identify individual ones of the subset of consumers based on context; and
outputting the anonymized shopping information of the subset of consumers for inclusion into crowd sourced shopping information of consumers in general, used to generate shopping recommendations for the plurality of consumers.

2. The method of claim 1, further comprising configuring data objectively specific to individual ones of the subset of consumers for the anonymizing operation to include one or more of: biographical data, names, contact data, birth dates, social security numbers, account numbers, user IDs, and passwords of the individual ones of the subset of the consumers.

3. The method of claim 1, wherein further comprising configuring contextual data that define a context to include one or more of: a location, an application query, and a type of purchase.

4. The method of claim 1, further comprising deriving one or more metrics of the crowd sourced shopping information of consumers in general based at least in part on the anonymized shopping information of at least a subset of the consumers outputted, wherein the deriving includes one or more of deriving a crowd-based shopping behavioral pattern, deriving a crowd-based shopping preference, deriving a shopping trend, inferring availability information for an item, or inferring a sales promotion.

5. The method of claim 4, the deriving is with respect to one or more of an item, an item descriptor, a purchase source, a purchase location, a purchase date, a purchase time, a purchase price, a form of payment, a source of payment funds, or a purchase promotion.

6. The method of claim 4, the deriving is with respect to one or more contexts:
shopping trips during which items are purchased,
sources visited during shopping trips,
travel routes of shopping trips,
sequences in which sources are visited during shopping trips,
items purchased during shopping trips,
frequency of purchases of items,
combinations of items purchased,
combinations of items purchased at sources,
times of shopping trips, or
geographic areas of shopping trips.

7. The method of claim 4, wherein the deriving of metrics includes deriving availability information with respect to a vendor, and wherein the availability information includes one or more of types of items available from the vendor, inventory counts of items available from the vendor, and cost of items available from the source,
wherein the cost of an item includes one or more of a price of the item and a purchase incentive applicable to the item, and the purchase incentive includes one or more of a coupon, a discount, a credit, and a customer reward.

8. The method of claim 4, wherein the deriving further comprises identifying items purchased and grouping the items purchased.

9. The method of claim 8, wherein the deriving further comprises assigning a crowd-based keyword to each group of items, wherein each keyword represents a crowd-based interest.

10. The method of claim 9, further comprising:
comparing the crowd-based keywords to keywords associated with one of the plurality of consumers to identify a set of one or more common keywords for the one consumer;
identifying one or more of the derived metrics for the set of one or more common keyword of the one consumer, based at least in part on a result of the comparing; and
displaying at least a portion of the identified one or more derived metrics to the one consumer via a shopping information device.

11. An apparatus, comprising a processor and memory configured to:
extract shopping information of a subset of a plurality of consumers from a plurality of electronic receipts of the subset of consumers;
anonymizing the shopping information of the consumers extracted from the plurality of electronic receipts of the subset of consumers, including first removing shopping information data that are objectively specific to individual ones of the subset of consumers, and second removing shopping information data that can subjectively identify individual ones of the subset of consumers based on context; and
outputting the anonymized shopping information of the subset of consumers to a cloud server for inclusion into crowd sourced shopping information of consumers in general, used to generate shopping recommendations for the plurality of consumers.

12. The apparatus of claim 11, further comprising to configure contextual data that define a context to include one or more of: a location, an application query, and a type of purchase.

13. The apparatus of claim 11, further comprising to derive a metric from the anonymized shopping information of at least a subset of the consumers, wherein the deriving includes one or more of deriving a crowd-based shopping behavioral pattern, deriving a crowd-based shopping preference, deriving a shopping trend, inferring availability information for an item, or inferring a sales promotion.

14. The apparatus of claim 13, wherein to derive the metric further includes to derive the metric with respect to one or more of an item, an item descriptor, a purchase source, a purchase location, a purchase date, a purchase time, a purchase price, a form of payment, a source of payment funds, a purchase promotion under which an item is purchased, item metadata, item label data, item branding data, item ingredients, and item certification.

15. The apparatus of claim 13, wherein to derive the metric further includes to derive the metric with respect to contextual shopping information of the consumers, wherein the contextual shopping information includes one or more of,
shopping trips during which items are purchased,
sources visited during shopping trips,
travel routes of shopping trips,
sequences in which sources are visited during shopping trips,
items purchased during shopping trips,
frequency of purchases of items,
combinations of items purchased,
combinations of items purchased at sources,
times of shopping trips, or
geographic areas of shopping trips.

16. The apparatus of claim 13, wherein to derive the metric further includes to derive availability information with respect to a vendor, and wherein the availability information includes one or more of types of items available from the vendor, inventory count of an item available from the vendor, and cost of an item available from the source,
the cost of an item includes one or more of a price of the item and a purchase incentive applicable to the item, and
the purchase incentive includes one or more of a coupon, a discount, a credit, and a customer reward.

17. The apparatus of claim 11, wherein to derive the metric further includes to assign a crowd-based keyword to each group of items, wherein each keyword represents a crowd-based interest.

18. A non-transitory computer readable medium encoded with a computer program that includes instructions to cause a processor to:
extract shopping information of a subset of a plurality of consumers from a plurality of electronic receipts of the subset of consumers;
anonymize the shopping information of the consumers extracted from the plurality of electronic receipts of the subset of consumers, including first removing shopping information data that are objectively specific to individual ones of the subset of consumers, and second removing shopping information data that can subjectively identify individual ones of the subset of consumers based on context; and
output the anonymized shopping information of the subset of consumers to a cloud server for inclusion into crowd sourced shopping information of consumers in general, used to generate shopping recommendations for the plurality of consumers.

19. The non-transitory computer readable medium of claim 18, further including instructions to cause the processor to derive a metric from the anonymized shopping information of at least a subset of the consumers, wherein to derive includes one or more of to derive a crowd-based shopping behavioral pattern, to derive a crowd-based shopping preference, or to derive a shopping trend, inferring availability information for an item, or inferring a sales promotion.

20. The non-transitory computer readable medium of claim 18, further including instructions to cause the processor to:
identify items purchased by the consumers; and
assign a crowd-based keyword to each group of items, wherein each keyword represents a crowd-based interest.
